(19) United States
(12) Patent Application Publication
(10) Pub. No.: US 2008/0307223 A1
(43) Pub. Date: Dec. 11, 2008

(54) APPARATUS AND METHOD FOR ISSUER BASED REVOCATION OF DIRECT PROOF AND DIRECT ANONYMOUS ATTESTATION

(76) Inventors: Ernest F. Brickell, Portland, OR (US); Jiangtao Li, Beaverton, OR (US)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/948,862

(22) Filed: Nov. 30, 2007

Related U.S. Application Data
(60) Provisional application No. 60/942,955, filed on Jun. 8, 2007.

(51) Int. Cl. H04L 9/32

(52) U.S. Cl. 713/158

(57) ABSTRACT

In some embodiments, a method and apparatus for issuer based revocation of direct proof and direct anonymous attestation are described. In one embodiment, a trusted hardware device convinces a verifier that the trusted hardware device possesses cryptographic information without revealing unique, device identification information of the trusted hardware device or the cryptographic information. Once the verifier is convinced that the hardware device possesses the cryptographic information, the verifier may issue a denial of revocation request to the trusted hardware device, including a base value B_{I} and a plurality of revoked pseudonyms (K₁, . . . , Kₙ) used for a plurality of suspect member keys during join procedures with an issuer. In response, the trusted hardware device issues a group denial revocation to prove that a private member key F does not match any one of a plurality of unknown, suspect keys F₁ . . . Fₙ formed from the revoked pseudonyms, where n is an integer greater than 1 and i is and integer from 1 to n. Other embodiments are described and claimed.

### RELATED APPLICATIONS

This application claims the benefit of U.S. Provisional Application No. 60/942,955 filed Jun. 8, 2007. The present application is related to co-pending U.S. patent application Ser. No. ______ filed Nov. 30, 2007, entitled “AN APPARATUS AND METHOD FOR ENHANCED REVOCATION OF DIRECT PROOF AND DIRECT ANONYMOUS ATTESTATION” and co-pending U.S. patent application Ser. No. 11/778,804 filed Jul. 17, 2007, entitled “AN APPARATUS AND METHOD FOR DIRECT ANONYMOUS ATTESTATION FROM BILINEAR MAPS”.

### FIELD OF THE INVENTION

One or more embodiments of the invention relate generally to the field of cryptography. More particularly, one or more of the embodiments of the invention relates to a method and apparatus for issuer based revocation of direct proof and direct anonymous attestation.

### BACKGROUND OF THE INVENTION

For many modern communication systems, the reliability and security of exchanged information is a significant concern. To address this concern, the Trusted Computing Platform Alliance (TCPA) developed security solutions for platforms. In accordance with a TCPA specification entitled “Main Specification Version 1.1b,” published on or around Feb. 22, 2002, each personal computer (PC) is implemented with a trusted hardware device referred to as a Trusted Platform Module (TPM). Each TPM contains a unique endorsement key pair (EK), which features a public EK key (PUBEK) and a private EK key (PRIVEK). The TPM typically has a certificate for the PUBEK signed by the manufacturer.

During operation, an outside party (referred to as a “verifier”) may require authentication of the TPM. This creates two opposing security concerns. First, the verifier needs to be sure that requested authentication information is really coming from a valid TPM. Second, an owner of a PC including the TPM wants to maintain as much privacy as possible. In particular, the owner of the PC wants to be able to provide authentication information to different verifiers without those verifiers being able to determine that the authentication information is coming from the same TPM.

One proposed solution to these security issues is to establish a Trusted Third Party (TTP). For instance, the TPM would create an Attestation Identify Key pair (AIK), namely a public AIK key and a private AIK key. The public AIK key could be placed in a certificate request signed with the PRIVEK, and subsequently sent to the TTP. The certificate for the PUBEK would also be sent to the TTP. Once the certificates are received, the TTP would check that the signed certificate request is valid, and if valid, the TTP would issue a certificate to the TPM.

Once a certificate is issued, the TPM would then use the public AIK and the TTP issued certificate when the TPM received a request from a verifier. Since the AIK and certificate would be unrelated to the EK, the verifier would get no information about the identity of the TPM or PC implemented with the TPM. In practice, the above-identified approach is problematic because it requires TTPs to be established. Identifying and establishing various parties that can serve as TTPs has proven to be a substantial obstacle.

Another proposed solution is set forth in a co-pending U.S. application Ser. No. 10/306,336, filed Nov. 27, 2002, which is also owned by the assignee of the present application. The proposed solution utilizes a direct proof method whereby the TPM could prove directly without requiring a trusted third party that an AIK has been created by a valid TPM without revealing the identity of the TPM. In that solution, each TPM has a unique private key. Unfortunately, an adversary may take a TPM and, using sophisticated means, extract the unique private key from the TPM.

In the Direct Proof method, there is a method given to be able to revoke a key that has been removed from a TPM. During the Direct Proof protocol, the TPM gets a base, b, and computes and reveals k=b^{f} mod n, where n is part of the public key, and f is part of the unique key held by the TPM. So if a verifier receives a value f0 that has been removed from a TPM, the verifier can check whether the Direct Proof was created using this value f0, by performing the computation k0=b^{f0} mod n, and checking to see if k=k0. Hence, if k=k0, then the Direct Proof was created using f0, and if k is not equal to k0, then the Direct Proof was created using some other private key.

One limitation of this method is that it requires that the verifier obtain the value of f0. It is conceivable that the adversary could have obtained the secret unique value from a TPM, and used it in a way that the verifier could not obtain the value of f0, but could know that for a particular k0, that value of f0 had been removed from the TPM. In U.S. application Ser. No. 10/306,336, one method was presented for dealing with this problem. It required the verifier to provide the value of the base b for each TPM to use when interacting with that verifier. This has the property that it allows the verifier to be able to link all interactions with that verifier.

### BRIEF DESCRIPTION OF THE DRAWINGS

The various embodiments of the present invention are illustrated by way of example, and not by way of limitation, in the figures of the accompanying drawings and in which:

FIG. 1 illustrates a system featuring a platform implemented with a Trusted Platform Module (TPM) that operates in accordance with one embodiment.

FIG. 2 illustrates a first embodiment of the platform including the TPM of FIG. 1.

FIG. 3 illustrates a second embodiment of the platform including the TMP of FIG. 1.

FIG. 4 illustrates an exemplary embodiment of a computer implemented with the TMP of FIG. 2.

FIG. 5 illustrates a flow diagram of a procedure to setup a TPM during manufacturing according to one embodiment.

FIG. 6 illustrates a flow diagram of a procedure to setup each platform manufactured according to one embodiment.

FIG. 7 is a flowchart illustrating a method for verifying that a cryptographic key stored within a trusted hardware device is uncompromised, in accordance with one embodiment.

FIG. 8 is a flowchart illustrating a method for a zero knowledge proof to show that two discrete logarithms are the same, in accordance with one embodiment.

FIG. 9 is a flowchart illustrating a method for conceptually illustrating the verification of a proof that two discrete logarithms are the same, in accordance with one embodiment.

FIG. 10 is a flowchart illustrating a method for convincing a verifier that a cryptographic key stored within a trusted hardware device is uncompromised, in accordance with one embodiment.

FIG. 11 is a flowchart illustrating a method for verifying that a membership of an owner of a trusted hardware device within a trusted membership group is not revoked, in accordance with one embodiment.

FIG. 12 is a flowchart illustrating a method for convincing a verifier that membership of an owner of a trusted hardware device within a trusted membership group is not revoked, in accordance with one embodiment.

### DETAILED DESCRIPTION

A method and apparatus for issuer based revocation of direct proof and direct anonymous attestation are described. In one embodiment a trusted hardware device convinces a verifier of possessing cryptographic information without revealing unique, device identification information of the trusted hardware device or the cryptographic information. This may be accomplished with an attestation methodology in which computations by the TPM involve exponentiations using a cryptographic (private member) key as an exponent, including but not limited to a direct proof (DP) protocol, a direct anonymous attestation (DAA) protocol or other like attestation protocol. In the DP or DAA scheme, during the issuing of a private membership key, the issuer obtains the identity of the member, but does not learn the membership private key.

In one embodiment, the issuer may determine that the member needs to be revoked, however, the issuer cannot obtain the private membership key through other means. With DP or DAA, there is no way to then revoke the private membership key belonging to that member. One embodiment provides a method for revoking the membership key belonging to the member from the information provided during issuing of the private membership key, even if there are no other transactions known that involve this member. This revocation method described is about three times faster than revocation methods based on transactions.

In one embodiment, the trusted hardware device proves to a verifier that a group digital signature used in an attestation protocol (e.g., a “DP signature,” a “DAA signature”) is not based on a revoked (compromised) private member key. In one embodiment, the verifier may issue a group denial of revocation request to the trusted hardware device to prove that a cryptographic key held by the trusted hardware device was not used to form any one of a group of revoked pseudonyms suspected of being compromised (suspect private membership key). If successful, a trusted member device provides the denial of an issuer revoked key to the verifier.

In one embodiment, an efficient revocation method for users whose hardware device has not been compromised is described. In DP or DAA, there are two main reasons to revoke a user: (1) the hardware device that contains the membership private key was broken by the adversary or (2) the user of the hardware device needs to be revoked while the hardware device remains trusted and uncorrupted. For the second case, instead of performing an expensive non-revoked proof, a hardware device in DP or DAA first makes sure that it has not been revoked, then signs a statement that it is not in the revocation list. Conventionally, revocation in the second case is handled in the same way as the first case, and it involves expensive zero-knowledge proofs.

In one embodiment, the functionality of the TPM, which is configured to prove to a verifier that information (e.g., cryptographic key, digital signature, digital certificate, etc.) from the TPM is uncompromised, is deployed as firmware. However, it is contemplated that such functionality may be deployed as dedicated hardware or software. Instructions or code forming the firmware or software are stored on a machine-readable medium. As described herein, DAA is a scheme that enables remote authentication of TPM, while preserving the privacy of the user of the platform that contains the TPM.

Herein, “machine-readable medium” may include, but is not limited to a floppy diskette, hard disk, optical disk (e.g., CD-ROMs, DVDs, mini-DVDs, etc.), magneto-optical disk, semiconductor memory such as read-only memory (ROM), random access memory (RAM), any type of programmable read-only memory (e.g., programmable read-only memory “PROM”, erasable programmable read-only memories “EPROM”, electrically erasable programmable read-only memories “EEPROM”, or flash), magnetic or optical cards, or the like. It is contemplated that a signal itself and/or a communication link can be regarded as machine-readable medium since software may be temporarily stored as part of a downloaded signal or during propagation over the communication link.

In the following description, certain terminology is used to describe certain features of one or more embodiments. For instance, “platform” is defined as any type of communication device that is adapted to transmit and receive information. Examples of various platforms include, but are not limited or restricted to computers, personal digital assistants, cellular telephones, set-top boxes, facsimile machines, printers, modems, routers, smart cards or other like form factor device including an integrated circuit, or other like device such as a bank card, credit card, identification card and the like including logic to perform issuer based revocation according to any one of the described embodiments. A “communication link” is broadly defined as one or more information-carrying mediums adapted to a platform. Examples of various types of communication links include, but are not limited or restricted to electrical wire(s), optical fiber(s), cable(s), bus trace(s), or wireless signaling technology.

A “verifier” refers to any entity (e.g., person, platform, system, software, and/or device) that requests some verification of authenticity or authority from another entity. Normally, this is performed prior to disclosing or providing the requested information. A “prover” refers to any entity that has been requested to provide some proof of its authority, validity, and/or identity. A “device manufacturer,” which may be used interchangeably with “certifying manufacturer,” refers to any entity that manufactures or configures a platform or device (e.g., a Trusted Platform Module).

As used herein, to “prove” or “convince” a verifier that a prover has possession or knowledge of some cryptographic information (e.g., signature key, a private key, etc.) means that, based on the information and proof disclosed to the verifier, there is a high probability that the prover has the cryptographic information. To prove this to a verifier without “revealing” or “disclosing” the cryptographic information to the verifier means that, based on the information disclosed to the verifier, it would be computationally infeasible for the verifier to determine the cryptographic information. Such proofs are hereinafter referred to as direct proofs.

Throughout the description and illustration of the various embodiments discussed hereinafter, coefficients, variables, and other symbols (e.g., “h”) are referred to by the same label or name. Therefore, where a symbol appears in different parts of an equation as well as different equations or functional description, the same symbol is being referenced.

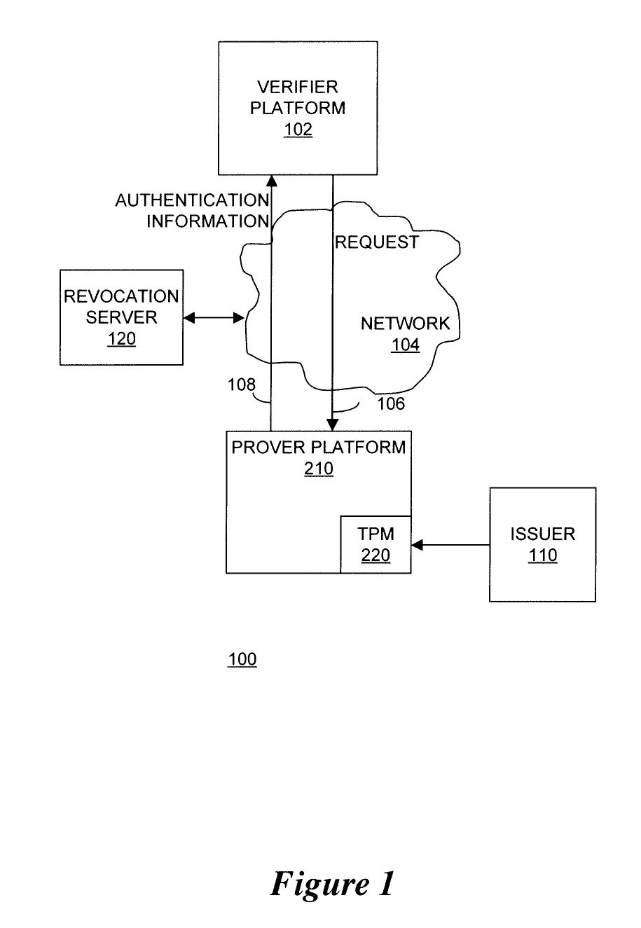

FIG. 1 illustrates system 100 featuring a platform implemented with a trusted hardware device (referred to as “Trusted Platform Module” or “TPM”) in accordance with one embodiment. A first platform 102 (Verifier) transmits an authentication request 106 to a second platform 200 (Prover) via network 120. In response to request 106, second platform 200 provides the authentication information 108. In one embodiment, network 120 forms part of a local or wide area network, and/or a conventional network infrastructure, such as a company's Intranet, the Internet, or other like network.

Additionally, for heightened security, first platform 102 may need to verify that prover platform 200 is manufactured by either a selected device manufacturer or a selected group of device manufacturers (hereinafter referred to as “issuer 110”). In one embodiment, first platform 102 challenges second platform 200 to show that it has cryptographic information (e.g., a private signature key including a private member key) issued by the issuer, which may be generated by a join protocol conducted by the issuer 110 and the member. Second platform 200 replies to the challenge by providing authentication information, in the form of a reply, to convince first platform 102 that second platform 200 has cryptographic information issued by issuer 110, without revealing the cryptographic information or any unique, device/platform identification information to the verifier 102 to enable prover 200 to remain anonymous to verifier 102.

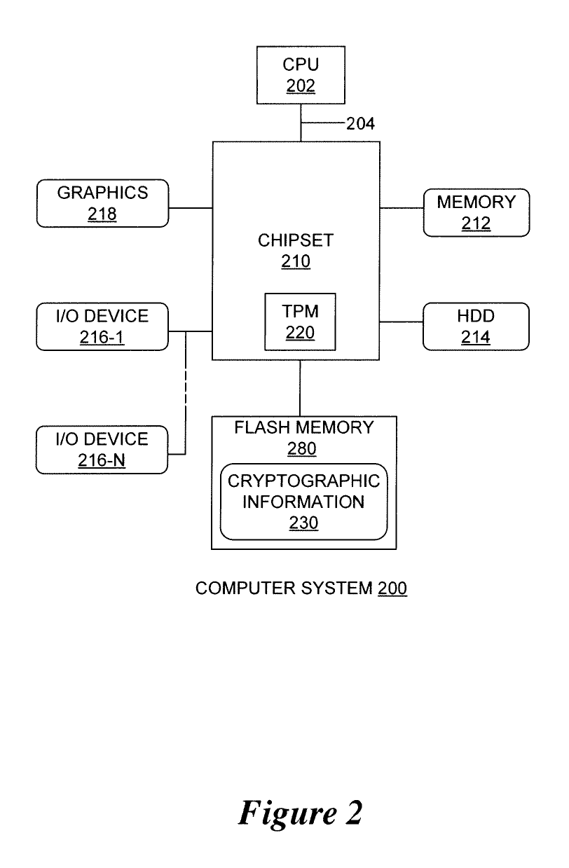

FIG. 2 is a block diagram further illustrating platform 200 including TPM 220 to convince a verifier that platform 200 possesses uncompromised cryptographic information without disclosure of the cryptographic information or any unique device identification information. Representatively, computer system 200 comprises a processor system bus (front side bus (FSB)) 204 for communicating information between processor (CPU) 202 and chipset 210. As described herein, the term “chipset” is used in a manner to collectively describe the various devices coupled to CPU 202 to perform desired system functionality.

Representatively, graphics block 218 hard drive devices (HDD) 214 and main memory 212 may be coupled to chipset 210. In one embodiment, chipset 210 is configured to include a memory controller and/or an input/output (I/O) controller to communicate with I/O devices 216 (216-1, . . . , 216-N). In an alternate embodiment, chipset 210 is or may be configured to incorporate graphics block 218 and operate as a graphics memory controller hub (GMCH). In one embodiment, main memory 212 may include, but is not limited to, random access memory (RAM), dynamic RAM (DRAM), static RAM (SRAM), synchronous DRAM (SDRAM), double data rate (DDR) SDRAM (DDR-SDRAM), Rambus DRAM (RDRAM) or any device capable of supporting high-speed buffering of data.

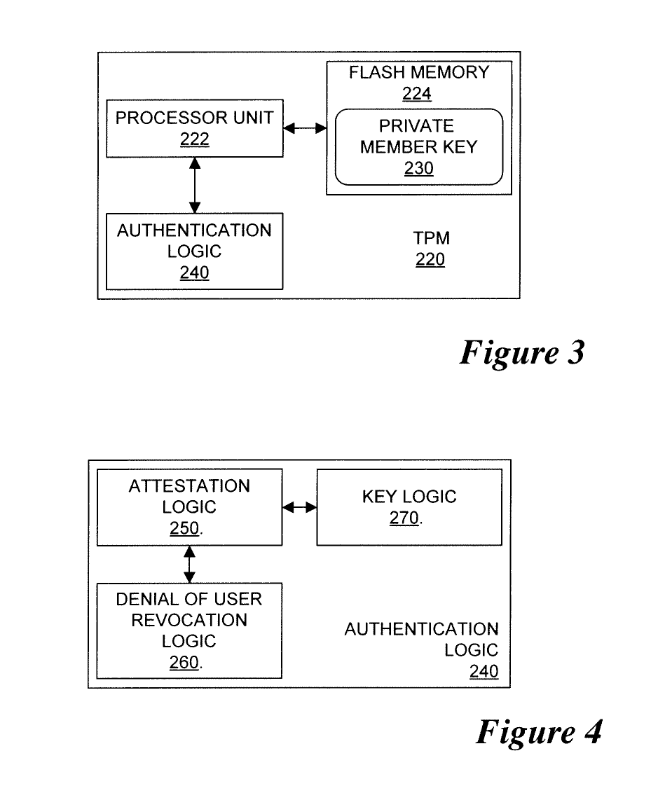

FIG. 3 further illustrates Trusted Platform Module (TPM) 220 of second platform 200, in accordance with one embodiment. TPM 220 is a cryptographic device that is manufactured by device manufacturer(s) 110. In one embodiment, TPM 220 comprises processor unit 222 with a small amount of on-chip memory encapsulated within a package. In one embodiment, the encapsulated memory may be used to store cryptographic (private signature) key 230 received from a certifying manufacturer. TPM 220 is configured to provide authentication information to first platform 102 that would enable it to determine that the authentication information is transmitted from a valid TPM. The authentication information used is non-unique data that would make it highly likely that the TPM's or second platform's identify can be determined, referred to herein as “unique, device identification information.”

In one embodiment, TMP 220 further comprises non-volatile memory 224 (e.g., flash) to permit storage of cryptographic information such as one or more of the following: keys, hash values, signatures, certificates, etc. In one embodiment, the cryptographic information is a cryptographic key received from a certifying manufacturer. As shown below, a hash value of “X” may be represented as “Hash(X)”. Of course, it is contemplated that such information may be stored within external memory 280 of platform 200 in lieu of flash memory 224. The cryptographic information may be encrypted, especially if stored outside TPM 220.

In one embodiment, TPM 220 includes authentication logic 240 to respond to an authentication request from a verifier platform. In one embodiment, authentication logic 240 convinces or proves to the verifier platform that TPM 220 has stored cryptographic information issued by an issuer (e.g., a certifying device manufacturer), without revealing the cryptographic information or any unique device/platform identification information to the verifier. As a result, authentication logic 240 performs the requested authentication while preserving the identity of the prover platform. Authentication logic 240 is further illustrated with reference to FIG. 4.

As illustrated, attestation logic 250 is configured to engage in an attestation protocol, as described in further detail below, to convince a verifier that the prover platform contains the cryptographic information from an issuer (e.g., a certifying manufacturer) without revealing the cryptographic information. As described below, key logic 270 performs platform set-up of TPM 220 to receive a unique, secret private pair (c,F), where F is a private membership key, F=c^{e} mod n, and e,n is a public key of an issuer, such as a certifying manufacturer of TMP 220.

As described in further detail below, denial of group revocation logic 260 provides additional functionality described below to convince or prove to a verifier platform that a private signature key held by the device was not used to generate any one of a group of revoked pseudonyms used to generate a private membership key in a join procedure as performed by attestation logic 250. It is appreciated that a lesser or better equipped computer than described above may be desirable for certain implementations. Therefore, the configuration of platform 200 will vary from implementation to implementation depending upon numerous factors, such as price constraints, performance requirements, technological improvements, and/or other circumstances.

In one embodiment, each hardware device, which is a member of a platform group, is assigned a unique, private signature key which may be comprised of a private member key mutually generated by the hardware device and an issuer as part of a join procedure conducted by the hardware device and the issuer. Representatively, a trusted hardware device, having a private signature key, is able to sign a message received as part of an authentication request from a verifier. However, in contrast to a traditional digital signature system, verification of a digital signature created with a unique, private signature key of a member device is verified using a group public key for the trusted platform group defined by an issuer. Use of its private signature key during attestation enables a member device of a platform group limits the disclosure of unique device identification information to an indication that the device is a trusted member of a platform group of trusted hardware devices defined by an issuer.

In one embodiment, authentication logic 240 enables one to prove that he is a member in good standing in a group without revealing any information about his identity. According to DAA, a member of a group has a credential (platform group membership certificate) that is used to prove membership in the group. In one embodiment, the credentials consist of a private key and public key. The private key is unique for every different member of the group. However, the public key is the same for all members of the group.

As described herein, the issuer, such as issuer 110, is the entity that establishes that a person (or an entity) is a member of a group, and then issues a credential to the member. As further described herein, the prover is a person or entity that is trying to prove membership in the group. If the prover is indeed a member in the group and has a valid credential, the proof should be successful. As further described herein, the verifier is the entity that is trying to establish whether the prover is a member of the group or not. So the prover is tying to prove membership to the verifier.

As shown in FIG. 4, to prove membership, a verifier requests that the prover digitally sign some messages using, for example, digital signature logic 260. If the verifier needs to know that the message was signed at the current time, then the verifier would create a random value, a nonce, which is given to the prover to include in the signature. The prover signs the message using a private signature key and sends the signature to the verifier. As described herein, the digital signature may be referred to as a “group digital signature.”

In one embodiment, verifier can verify the group digital signature using the group public key of a trusted platform group and, if verification succeeds, the verifier knows that the prover is a trusted member device of the group. However, the verifier does not learn which member created the digital signature. If the nonce was used, the verifier knows that the group digital signature was created between the time she sent the nonce and the time the group digital signature was received. Hence, as described herein, a prover may be anonymous to a verifier and, if verified as a trusted member device, the prover remains anonymous to the verifier.

In one embodiment, TPM 220 may be incorporated on a smart card, including a form factor of a PCMCIA card for insertion into a PCMCIA slot, or incorporated on an identification device such as a driver's license, identification card, credit card or other like configuration having the form fact or of a standard driver's license/credit card (e.g., 2⅛×3⅜ inches) and including an integrated circuit. According to such a configuration, use of TPM 220 on, for example, a driver's license would enable conformance with the Real ID Act of 2005. The REAL ID Act of 2005 is Division B of an act of the United States Congress titled Emergency Supplemental Appropriations Act for Defense, the Global War on Terror, and Tsunami Relief, 2005, Pub. L. No. 109-13, 119 Stat. 231 (May 11, 2005).

The Real ID Act is a law imposing federal technological standards and verification procedures on state driver's licenses and identification cards, many of which are beyond the current capacity of the federal government, and mandating state compliance by May 2008. One attempt to implement the Real ID Act on state driver's licenses generally exposes privacy sensitive information of the holder of the card since such information is made computer readable. Unfortunately, such privacy sensitive information is sometimes sold, without the owners consent, and used to conduct fraudulent transactions in the owner's name but without the owner's consent. Such activity is a form of identity theft, which is a widespread phenomenon that is destroying the credit of innocent victims on a daily basis.

In view of the above-described configuration, using an embodiment for example, in one, the Department of Motor Vehicle, or DMV, is the issuer and engages in a setup procedure to create a group public key and a group issuing private key. The issuer publishes the public key and keeps the group issuing private key private. According to such a procedure, for each issued driver's license, a general procedure is followed to provide a user private key from the issuer (DMV). For example, the user private key together with the group public key may be the user's credential for a trusted membership group.

In one embodiment, a method is described for revoking credentials of a member. As described herein, revoked user credentials may include a group of revoked pseudonyms used to generate respective private membership keys in a join procedure suspected of being compromised private member keys. For example, if a member's private key gets removed from the storage device of the member and becomes known to law enforcement authorities, it is published widely so that if a verifier knows that this compromised private key, then the verifier is able to check whether a particular signature was created using this compromised private member key. In an alternative method, the verifier does not need to know the comprised member's private keys. Suppose the member had performed a proof of membership, and the issuer or some other entity determines that the prover in that case should be placed on the revocation list. Then, later in another transaction, after the prover has proven that she is a member of a group, the verifier can ask the prover to prove that she was not the revoked member who was the prover in that early case.

In accordance with such an embodiment, when TPM 220, as well as authentication logic, as shown in FIG. 4, is incorporated onto a card having a form factor such as a standard driver's license, credit card or other like smart card device for accessing bank machines or the like, a holder of the card can engage in a verification procedure to prove that the owner of the card is not a revoked member without requiring, for example, the issuer (DMV) to have a copy of the compromised private keys.

A “trusted platform family” or “trusted platform group” may be defined by the device manufacturer (issuer) to include one or more types of platforms or devices. For instance, a platform family may be the set of all platforms (members) that have the same security relevant information. This security relevant information could contain some of the information that is included in the EK or AIK certificate in the TCPA model. It could also include the manufacturer and model number of the particular platform or device. Similarly, an issuer may define a trusted platform group in which member devices (e.g., a smart card with a credit/identification card form factor) become members as part of a join procedure where a private signature key is mutually generated by the member device and the issuer according to a private member key and a group membership certificate.

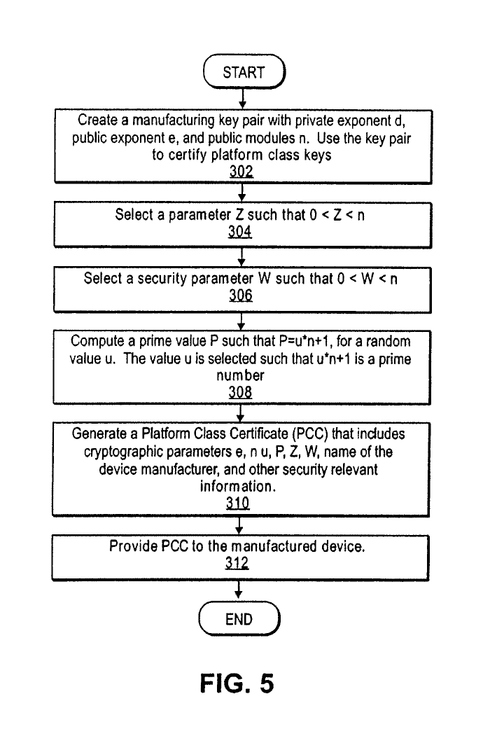

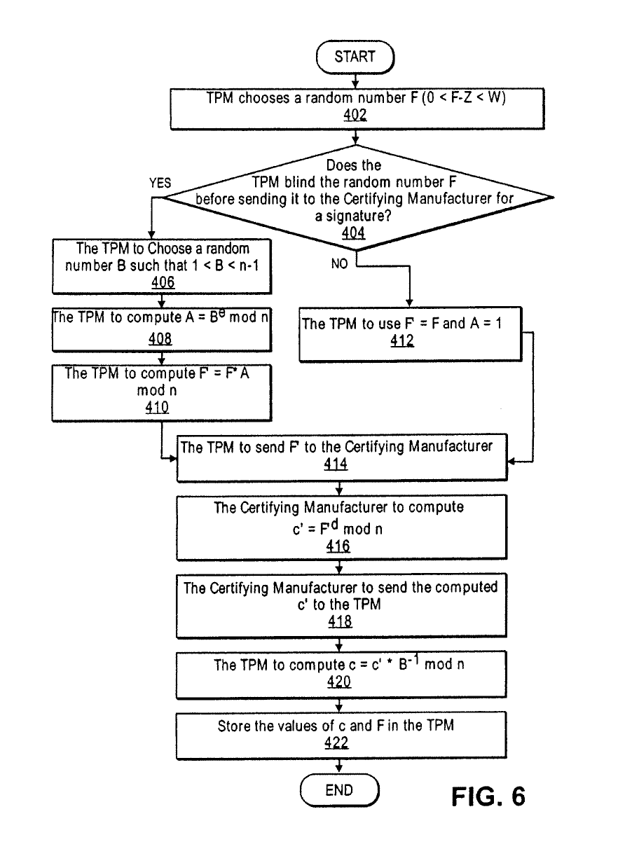

For each platform family/group, an issuer creates the cryptographic parameters that are used for that platform family. The issuer creates a signature key that it uses in the join process in the generation of the secrets for the devices (e.g., platform 200 or TPM 220). The issuer may be a manufacturer of such devices as shown in FIGS. 5 and 6.

FIG. 5 is a flowchart illustrating a method 300 to form a platform family certificate (PFC) (platform group membership certificate) in accordance with one embodiment. In one embodiment, the issuer (device manufacturer) uses a public key cryptographic function (e.g., Rivest, Shamir and Adelman (RSA) function) to create an RSA public/private key pair with public modulus n, public exponent e, and private exponent d (block 302). The public key is based on values e,n while the private key is based on d,n. This can be created using well known methods, such as those described in Applied Cryptography, by Bruce Schneier, John Wiley & Sons; ISBN: 0471117099; Second Edition (1996). In one embodiment, modulus n should be chosen large enough so that it is computationally infeasible to factor n.

The issuer specifies a parameter Z, which is an integer between zero (0) and n (block 304). The device manufacturer specifies a security parameter W, which is an integer between zero (0) and n (block 306). However, picking W too small or too large may introduce a security failure. In one embodiment of the invention, W is selected to be approximately 2¹⁶⁰. Selecting W to be between 2⁸⁰ and the square root of n is recommended. In one embodiment of the invention, the device manufacturer computes a prime number P, such that P=u*n+1 (block 308). Any value of u can be used as long as P is prime; however, to retain an acceptable level of security, the value P should be large enough so that computing a discrete logarithm “mod P” is computationally infeasible.

In one embodiment, the Direct Proof public key of the device manufacturer consists of the cryptographic parameters e,n,u,P,Z,W. These parameters will be used by a verifier to verify a direct proof signature created by a device. The device manufacturer generates a Platform Family/Group Membership Certificate that comprises cryptographic parameters e, n, u, P, Z, W, the security relevant information of the platform family, and the name of the device manufacturer (block 310). In one embodiment, the parameters u and P would not both be included since given n and one of these parameters, the other can be computed by P=u*n+1. In one embodiment, the device manufacturer uses the same cryptographic parameters e, n, u, P, W for several different platform families, and just varies the value Z for the different platforms. In this case, the values of Z may be chosen to differ by approximately or at least 4W, although the selected difference is a design choice.

Once the Platform Family Certificate is generated, the device manufacturer provides the Platform Family Certificate to the platforms or devices it manufactures which belong to that particular platform family (block 312). The distribution of cryptographic parameters associated with the Platform Family Certificate from a prover (e.g., second platform 200 in FIG. 1) to a verifier may be accomplished in a number of ways. However, these cryptographic parameters should be distributed to the verifier in such a way that the verifier is convinced that the Platform Family Certificate came from the issuer of the Group Membership keys.

For instance, one accepted method is by distributing the parameters directly to the verifier. Another accepted method is by distributing the Platform Family Certificate signed by a certifying authority, being the issuer as one example. In this latter method, the public key of the certifying authority should be distributed to the verifier, and the signed Platform Family Certificate can be given to each platform member in the platform family (prover platform). The prover platform can then provide the signed Platform Family Certificate to the verifier.

FIG. 6 is a flowchart illustrating a method 400 for the setup performed for a prover platform manufactured according to one embodiment, such as, for example, by key logic 270, as shown in FIG. 4. The TPM of the prover platform chooses a random number F such that 0<F-Z <W (block 402). The TPM may blind this random number F before sending it to the certifying manufacturer for signature (block 404). This blinding operation is performed to obfuscate the exact contents of the random number F from the certifying manufacturer. In one embodiment, the TPM chooses a random value, B, where 1<B <n−1 (block 406), and computes A=B^{e} mod n (block 408). Then, the TPM computes F′=F*A mod n (block 410). If the TPM does not blind F, then the TPM uses F′=F and A=1 (block 412).

After performing these computations, TPM sends F′ to the certifying manufacturer (block 414). The certifying manufacturer computes c′=F′^{d} mod n (block 416), and provides c′ to the prover (block 418). The TPM of the prover computes c=c′*B⁻¹ mod n (block 420). Notice that this implies that c=F^{d} mod n. The values c and F are then stored in the TPM or external storage within the prover (block 422). As described herein, F is referred to as a signature key of the TPM, whereas the secret pair c,F are referred to as cryptographic information and may also be referred to herein as a “member key”. As described herein, F may be referred to as the “pseudonym exponent”.

As described herein, Direct Proof (DP) is a method for proving to a verifier that a cryptographic key is held in hardware without revealing information about the identity of the hardware device. In a DP system, an issuer creates a public/private key pair. The issuer uses his private key to create and issue member private keys to members. The DP was created for the application in which the members are hardware devices. Each member goes through a JOIN process with the issuer to receive a private signature key including a member key. With a private signature key, a member can sign a message.

Similarly, a verifier can verify that the signature is valid using the issuer's public key. This is the important distinction between DP and a traditional public/private key signature scheme. In the traditional scheme, a user's signature is validated using the user's public key. Thus the user's public key must be revealed to validate a signature. The public key is unique to the individual and thus identifies the user. In the DP scheme, the member's signature is validated using the issuer's public key. Thus all members can have their signatures validated using the same public key. It can be proven that a signature created by a member does not identify which member created the signature.

Operation of the TPM to perform a direct proof to convince a verifier that the hardware device possesses cryptographic information from a certifying manufacturer is described within co-pending U.S. application Ser. No. 10/675,165, filed Sep. 30, 2003. In the Direct Proof scheme, the prover's signature used in a direct proof (“direct proof signature”) is validated using a public key if the platform manufacturer (issuer). Thus all members can have their signatures validated using the same public key. It can be proven that a direct proof signature created by a member does not identify which member created the direct proof signature.

To prove to a verifier that the TPM contains a unique secret pair, the TPM may obtain a value for B to use as a base according to the random base option. For example, the TPM may compute K=B^{F} mod N and give B,K to the verifier in response to a signature request. As described herein, the value K is referred to as the “pseudonym” for the direct proof signature and B is referred to as the “base” for the direct proof signature. The TPM then constructs a direct proof signature, which is a proof that the TPM possesses F,c, such that F=c^{e} mod n and K=B^{F} mod P, without revealing any additional information about F and c. A method for constructing a direct proof signature is given in co-pending U.S. application Ser. No. 10/306,336, which is also owned by the assignee of the present application. TPM may use different B values each time the TPM creates a new direct proof signature so that the verifiers may not know that they received the proof from the same TPM according to the random base option.

Referring again to FIG. 4, in one embodiment, TPM 220 includes denial of revocation logic 260 to handle revocation of member keys. The member keys are held in hardware, but it is possible that the keys can be removed. In this case, verifiers would revoke any removed key and quit accepting direct proof signatures generated with a revoked (unknown suspect) key. As a part of the signature process, the member selects a random base B and a public key (e,n) of a certifying member to compute k=B^{F} mod P where F=c^{e} mod n# and (c, F) is a private key of the trusted member device. The values of B and k are revealed as part of the signature. It is proven that if random bases are used, then given two different signatures, it is computationally infeasible to determine whether the two signatures were created with the same pseudonym exponent, F or different pseudonym exponents, F's.

However, if adversaries have removed the secret pseudonym exponents F's from some number of hardware devices, (say F1, F2, F3) and if a verifier has these pseudonym exponents, then the verifier can tell if a given signature was created using one of these pseudonym exponents, by checking whether K=B^{F1} mod P or B^{F2} mod P or B^{F3} mod P. This works for the case where the verifier has the secret F's that were removed from the hardware device. But it does not work in the case where the verifier suspects that a member key has been removed from a hardware device, but he does not have the member key, specifically the exponent F.

To give the verifier the ability to revoke a member key that he suspects is compromised, the Direct Proof (and DAA) methods support the named base option. In one embodiment, according to the named base option, the verifier would provide the base B, which in one embodiment, is derived from the name of the verifier. The member would use this base B in the Direct Proof signature instead of picking a random B. As long as the verifier was using the same base, the verifier could tell if two signatures sent to him used the same pseudonym exponent, F, because the two signatures would produce the same pseudonym, B^{F} mod P.

Thus if a verifier, using the named base option, received a direct proof signature, and suspected that the member key used to create that signature had been compromised, the verifier would be able to reject further signatures by this member key as long as he was using the same named base. However, the only way for a verifier to make effective use of the named base option is to use the same named base for a long time. This is not ideal from a privacy perspective, since it enables a verifier to link all of the transactions performed by a member with the verifier's named base.

Direct Anonymous Attestation (DAA) is a scheme that enables remote authentication of TPM, while preserving the privacy of the user of the platform that contains the TPM. The concept of DAA is very similar to Direct Proof. The basic idea underlying the DAA scheme is as follows. During setup, the issuer chooses a strong RSA modulus N, and random numbers R₀, R₁, S and Z in the quadratic residues modulo N. The issuer publishes (N, R₀, R₁, S, Z) as the group public key and keeps the factorization of N as the issuing private key.

In the Join protocol, a user chooses a secret message f, splits it into two messages f₀ and f₁, and engages an interactive protocol with the issuer. In the end of the protocol, the user obtains A, e and v such that A^{e}R₀^{f0}R₁^{f1}S^{v}═Z (mod N). The user's private key is then (A, e, f, v). During the interaction between the prover and the verifier, the prover proves that she has a valid private key without revealing any information the private key. The technique the prover uses is a zero-knowledge proof of knowledge. The prover proves to the verifier the knowledge of f₀, f₁, A, e and v such that A^{e}R₀^{f0}R¹^{f1}S^{v}═Z (mod N). During the zero-knowledge proof, the prover intentionally reveals (B, B^{f}) as a part of the signature, where B is a random number. The (B, B^{f}) pair is used for the revocation purpose.

In the embodiments described, the method and apparatus for issuer based revocation is compatible with both direct proof and direct anonymous attestation, as described. A recent disclosure showed that DAA could be modified so that the computations could be done using elliptic curves rather than modular exponentiation as described within co-pending U.S. application Ser. No. 11/778,804, entitled “An Apparatus and Method for Direct Anonymous Attestation From Bilinear Maps,” filed on Jul. 17, 2007. In the embodiments described, the method and apparatus for issuer based revocation is also compatible with the direct anonymous attestation using elliptic curves. In this latter case, the pseudonym is K=B^{f} where the computation is over the elliptic curve group instead of modular multiplication (i.e., using the same notation as that described within co-pending U.S. application Ser. No. 11/778,804.)

As described within co-pending U.S. application Ser. No. 11/778,804, an additional revocation method to the Direct Proof methods is provided. Suppose a verifier using the random base option received a DP signature and then decided that the member key that had created that signature was compromised. Based on the information presented in the DP signature, the verifier can place the member key on a revocation list. The verifier can reject any future signatures that are created using that same member key. In addition, the verifier could tell other verifiers that the one signature was created using a possibly compromised member key, and the other verifiers can also reject any future signatures created using that same member key. A member can create a DP signature as before. The verifier can then present the member with some number of previous signatures and ask the member to prove that he did not produce any of those previous signatures. The member is able to do this in a way that convinces that verifier that he answered correctly, and so that the verifier gets no information other than the correct answer.

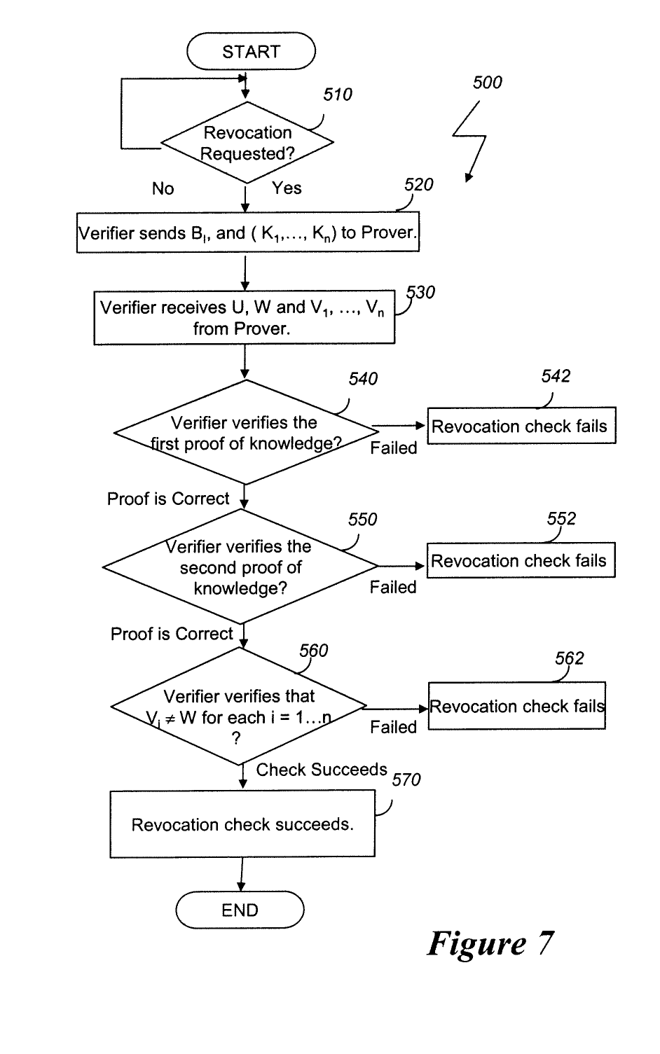

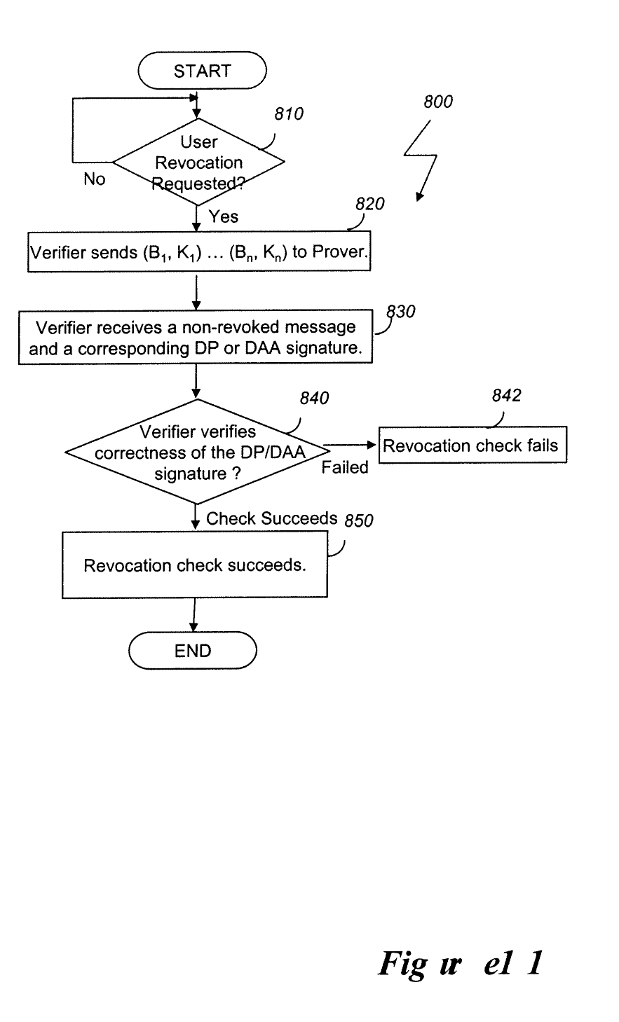

In one embodiment, an issuer based revocation method of suspect member keys in the random base option is described that applies to DP, DAA, and other like anonymous attestation protocols is described. As shown in FIGS. 7 and 10, let B_{I} be a base derived from the issuer's long term base-name. During the JOIN process, each member reveals a pseudonym K=B_{I}^{F} mod P, for a secret F that is unique to the member, and a modulus P that is common to all of the members in the group. If sometime after issuing, the issuer determines that a group member needs to be revoked, the issuer puts the corresponding K into the issuer based revocation list. In DP or DAA, to prove membership, a member generates a signature such that it can be verified by the verifier. With this new invention, the member in addition has to prove that she did not generate K in the JOIN process, for each K in the issuer based revocation list.

For each signature produced in DP or DAA, a prover reveals a pseudonym K=B^{F} mod P, for a base B, a secret F that is unique to the member, and a modulus P that is common to many provers. In the random base option, the prover chooses the base B at random. In the named base option, the verifier provides a name, and B is determined from that name. In one embodiment, we assume that the random base option is being used.

Suppose that a verifier received revoked pseudonyms (K₁, . . . , Kₙ) from the issuer. The issuer suspects that the members with secrets F₁ . . . Fₙ are corrupted where K₁=B₁^{F1} mod P, . . . . K₀=B₁^{Fn} mod P. The verifier would then perform the following protocol to reject any future signatures generated by the secret F₁ . . . Fₙ, as shown in FIGS. 7 and 10.

FIG. 7 is a flowchart illustrating a method 500 performed by a verifier platform to verify that a cryptographic key stored within a TPM is uncompromised, in accordance with one embodiment. Representatively, at process block 510, the verifier platform determines whether it is aware of a group of revoked pseudonyms used to generate a private membership key in a join procedure suspected of being compromised (suspect private member key). Suppose that a verifier received revoked pseudonyms (K₁, . . . , Kₙ) from the issuer. The issuer suspects that the members with secrets F₁ . . . Fₙ are corrupted where K₁=B₁^{F1} mod P, . . . , Kₙ=B₁^{Fn} mod P. In one embodiment, the verifier platform performs the process described below for the suspect signatures by issuing a revocation request at process block 510.

In the embodiments described, the verifier platform does not contain a copy of the suspect keys F₁-Fₙ that are suspected of being compromised. Once the member provides a base B, a pseudonym K, and a DP or DAA signature for this pair, at process block 520, verifier platform transmits base B_{I} and revoked pseudonyms (K₁, . . . , Kₙ) of the group of revoked pseudonyms, generated with the unknown, suspect keys F₁-Fₙ, where F is secret, cryptographic information held by the prover platform. In response, the verifier platform will receive one or more values U, W and V₁, . . . , Vₙ from prover platform, computed using the base B_{I} and revoked pseudonyms (K₁, . . . , Kₙ) at process block 530.

In one embodiment, validation of the cryptographic key (F) stored within prover platform is performed as illustrated with reference to process blocks 540-570. The prover platform will generate random value R. In one embodiment, the random value R is chosen in some specified interval. At process block 540, verifier platform received a proof from prover platform that for i=1 . . . n there exists a value R such that:

U=B_{I}^{R} mod P and Vᵢ=Kᵢ^{R} mod P. (1)

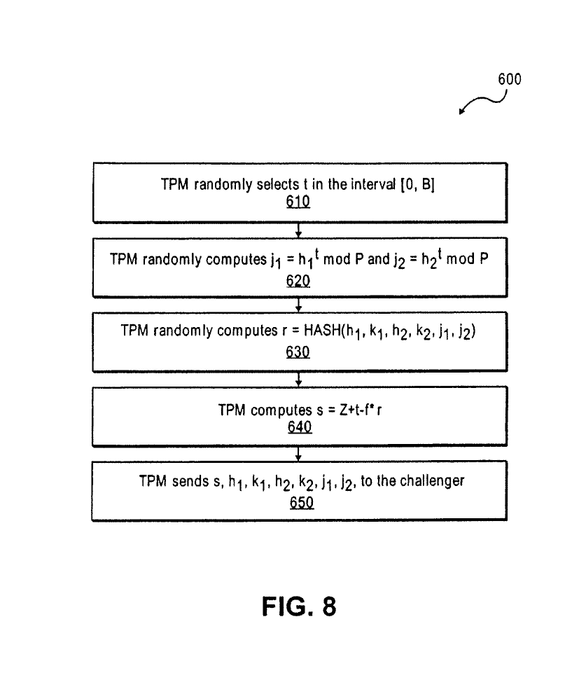

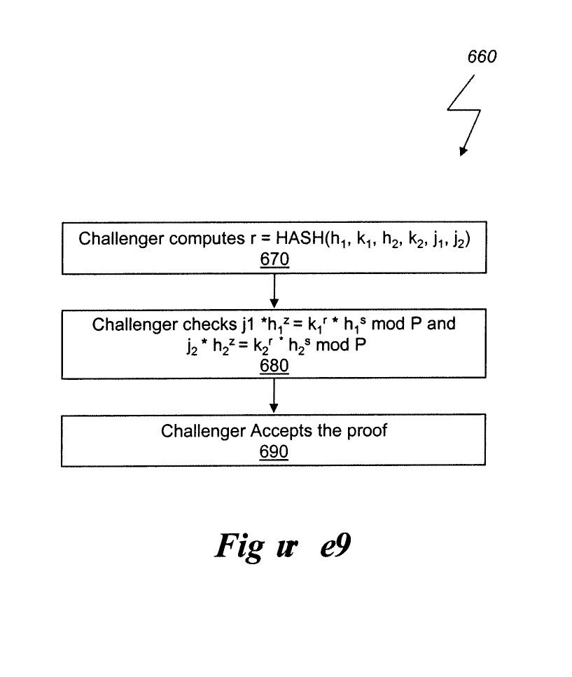

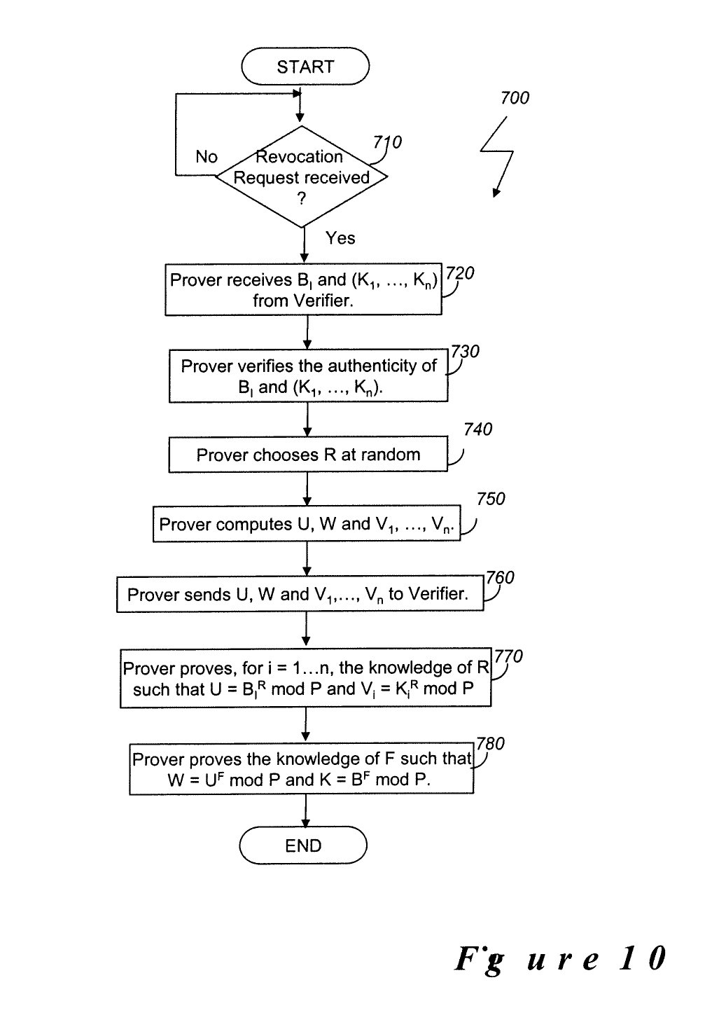

In one embodiment, the received proof of the existence of the value R is in the form of a zero knowledge proof. One embodiment of such a zero knowledge proof for proving that two pairs (U, B_{I}) and (Vᵢ, Kᵢ) have the same discrete logarithm is given in FIGS. 8 and 9. Otherwise, the revocation check fails at process block 542. At process block 550, a verifier platform verifies a second proof of knowledge and receives a proof that there exists a value F such that:

W=U^{F} mod P and K=B^{F} mod P. (2)

Again, the proof of the existence of the value F may be performed using a zero knowledge proof. One embodiment of such a zero knowledge proof for proving that two pairs (W,U) and (K,B) have the same discrete logarithm is given in FIGS. 8 and 9. Otherwise, the revocation check fails at process block 552.

Accordingly, once verifier platform is convinced of the existence of values Rand F, in one embodiment, at process block 560 verifier platform checks the values of Vᵢ. If there exists an I such that Vᵢ=W mod P for some 1≦i≦n, then the verifier knows that prover platform key, F, is equal to an unknown, suspect key, Fᵢ and revocation fails at process block 562. If:

Vᵢ≠W mod P for 1 . . . n (3)

then the verifier knows that prover platform key, F, is not equal to any of the unknown, suspect keys, F₁ . . . Fₙ. The reason that the verifier is convinced that F is not equal to any of F₁ . . . Fₙ is the following. Suppose that F=Fᵢ mod (P-1) for some i. Then Vᵢ=Kᵢ^{Ri}=B_{I}^{Ri Fi}=B_{I}^{Ri F} mod P. But we also have that W=U^{F}=B_{I}^{R F} mod P. Thus Vᵢ=W mod P. Thus U=W mod P if and only if F=Fᵢ mod P.

If Vᵢ≠W mod P for 1 . . . n, prover platform key F is not equal to any of the unknown, suspect keys F₁ . . . Fₙ. Accordingly, at process block 570, the verifier receives a denial that the prover signature key F was used to generate any one of the revoked K₁, . . . , Kₙ in the join procedure, referred to herein as “proving the denial of a revoked key”. Hence, the revocation check succeeds at process block 570. Otherwise, Vᵢ=W mod P for some i, 1≦i≦n, and the verifier platform receives confirmation that the prover platform was indeed using a compromised key Fᵢ for the signature.

In one embodiment, the prover platform denies the signature key F of the prover was used to form a suspect signature by using a standard zero knowledge proof, as shown in FIGS. 8 and 9. As described herein, the standard zero knowledge proof for proving that two pairs have the same discrete logarithm is provided as follows. Specifically, given a set of integers k₁, h₁, k₂, h₂, and a modulus P, the zero knowledge proof will prove that there exists an e such that k₁=h₁^{f} mod k₂ and h₂^{f}=W^{e} mod P without revealing any information about f.

In one embodiment of a zero knowledge proof to show that two discrete logarithms are the same was given in co-pending U.S. application Ser. No. 10/306,336, which is also owned by the assignee of the present application. FIG. 8 is a flow diagram 600 illustrating this zero knowledge proof. Suppose that f is in the interval between Z and Z+W. (Z could be 0, as in the case of equation 1 above.) Let B=W*2^{Sp+HASH}^{^{—}}^{Length}, where Sp is a security parameter and HASH_length is the length in bits of the output of the Hash function HASH. In one embodiment Sp is chosen large enough, for example Sp=60, so that the values of s computed below do not reveal useful information about f.

At process block 610, TPM randomly selects value t in the interval [0, B]. TPM may then compute j₁=h₁^{t} mod P and j₂=h₂^{t} mod P at process block 620. TPM may then compute r=HASH(h₁, k₁, h₂, k₂, j₁, j₂) at process block 630. At process block 640, TPM may compute s=Z+t-f*r. Finally, at process block 650, TPM may send s, h₁, k₁, h₂, k₂, j₁, j₂ to the verifier. According to one embodiment, the verifier may then verify the proof.

FIG. 9 is a flow diagram 660 conceptually illustrating the verification of a proof that two discrete logarithms are the same, according to one embodiment. At process block 670, the challenger may compute r=HASH(h₁, k₁, h₂, k₂, j₁, j₂). The challenger may then check that j₁*h₁^{z}=k₁^{r}*h₁^{s} mod P and j₂*h₂^{z}=k₂^{r*h}₂^{s} mod P at process block 680. If the checks of process block 720 pass, the challenger may accept the proof at process block 690.

FIG. 10 is a flowchart illustrating a method 700 performed by a prover platform in response to receipt of a revocation request. As described herein, a verifier platform, once convinced of the existence of a cryptographic key stored within hardware device, may verify that the stored cryptographic key is uncompromised. In accordance with one embodiment, such functionality is provided by denial of group revocation logic 260 of authentication logic 240 of TPM 220, as illustrated with references to FIGS. 2 and 3. Representatively, at process block 710, prover platform determines whether a user revocation request is requested. Once requested, the functionality of process blocks 720-780 is performed.

At process block 720, verifier platform receives base B_{I} and revoked pseudonyms (K₁, . . . , Kₙ) received in a join procedure to generate unknown, suspect keys F₁ . . . Fₙ. At process block 730, the verifier gives B_{I} and (K₁, . . . , Kₙ) to the prover platform. Let F be the secret (private member key) held by this member. At process block 730, the prover platform first verifies the authenticity of the revoked pseudonyms (i.e., checks whether they are signed by a trusted revocation server), then select at random at process block 740. At process block 750, the prover platform then computes for i=1 . . . n: U=B^{R} mod P, V₁=Kᵢ^{R} mod P, W=U^{F} mod P. At process block 760, the prover platform sends U, W and (V₁, . . . , Vₙ) to the verifier. At process block 770, for i=1 . . . n, the prover platform proves to the verifier that there exists R such that U=B_{I}^{R} mod P and Vᵢ=Kᵢ^{R} mod P. This is done using the standard zero knowledge proof, as described above (see FIGS. 8 and 9.)

At process block 780, the member proves to the verifier that there exists F such that

W=U^{F} mod P and K=B^{F} mod P. (4)

As indicated above, in one embodiment, the proofs are performed according to the zero knowledge proof as described in FIGS. 8 and 9. As also indicated above, assuming that Equation (4) evaluates to true, prover key F is not equal to unknown, suspect keys F₁ . . . Fₙ. Hence, the prover denies that any of the revoked pseudonyms were used to generate a signature key F of the prover platform. Otherwise, if Equation (4) evaluates to false, prover key F is equal to one of unknown, suspect keys F₁ . . . Fₙ. As a result, the prover platform would fail to prove denial of the group of revoked pseudonyms. Accordingly, the verifier platform would fail to authenticate the prover platform, since the prover platform is using a compromised key.

One embodiment provides enhanced security capabilities to the named based option described above. However, in one embodiment, a verifier platform is prohibited from submitting to prover platforms all signatures previously received. Namely, by submitting all previously received signatures to a prover platform, a prover platform that had previously submitted a signature would be required to identify the respective signature. As a result, the verifier platform would be able to link all previous signatures from the prover platform together. In one embodiment, several methods are provided to prevent abuse of the revocation capability described by one or more embodiments herein.

In one embodiment, a prover platform is provided with a built-in capability to limit the number of revoked pseudonyms that the verifier can present for denial. This is a reasonable method since a very small percentage of devices will be compromised and have their keys removed. However, if more than the limit get compromised, in one embodiment, devices may be rekeyed. A device would be rekeyed only after the device had proven that it was not a compromised device. Another method is to put into the device one or more public keys (hashes of public keys) of revocation authorities (revocation servers). Accordingly, a verifier platform would give a denial of signature if the request for denial was approved by one of these revocation authorities. The approval could be indicated by having the revocation server sign the request for denial, specifically to sign B₁, or to sign a list of (K₁, . . . , Kₙ) for all of the items on the revocation list. In one embodiment, the verifier may be required to prove authorization before supplying a signed revocation list.

In applying the revocation methods to a specific situation, multiple methods may be supported. There may be one revocation list of private keys which have been removed from the hardware devices and known to the verifiers. The verifiers can check a signature created by a prover to see that it was not generated by one of these private keys. There may be another revocation list of member keys revoked because the specific member has been revoked. In this instance, the keys can be revoked based on the named base pseudonym created during issuing. So this list would have the named base B_{I}, and a list of pseudonyms K₁, K₂, . . . , that were provided during issuing. There may be another revocation list of member keys revoked because during some transaction, the device was suspected of being compromised. In this case, the pair consisting of the base B, and the pseudonym, K=B^{F} created by the member during this transaction would be placed on a revocation list. The prover would prove that he was not on this list using the technique revealed in patent application (give the previous patent application for proof of not on a revocation list.)

In one embodiment, there may be cases where the revocation list consists of a list of pseudonyms, (B₁, K₁), (B₂, K₂), . . . , but for which the device key itself is not suspected of being compromised. In this case, the device could just check that it was not one of these pseudonyms, by checking for the F held by the device, that Bᵢ^{F} is not equal to Kᵢ for all of the pairs on the list. If these checks passed in the device, then the device would sign a message, using a Direct Proof or DAA signature or similar, stating that it was not the creator of any of these pseudonyms. If many of the pseudonyms on the list had the same named base, B_{I}, then for the check, the device could check all of those items with a single computation of B_{I}^{F}. In one embodiment, these revocation lists that are processed by the member device would typically be signed and the member device would verify the signature using a public key for which the public key or a cryptographic hash of the public key was embedded in the member device.

As indicated above, in DP or DAA, there are two main reasons to revoke a user: (1) the hardware device that contains the membership private key was compromised (or suspected to be compromised) by the adversary or (2) the user of the hardware device needs to be revoked while the hardware device held by the user is not suspected of being compromised. For example, a user processes a valid DP or DAA membership private key. The user abuses his group privilege and was revoked from the group. However, his hardware device is still uncompromised or not known or suspected of being compromised.

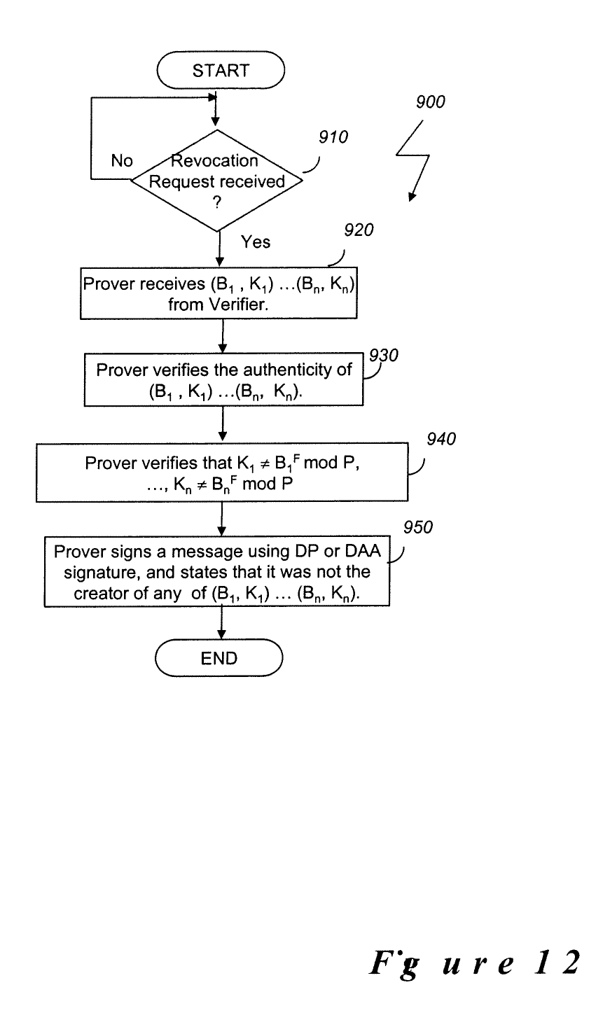

In one embodiment, a revocation list for the second case includes base and pseudonym pairs (B₁, K₁) . . . (Bₙ, Kₙ). The verifier wants to reject signatures by the hardware devices that contain the secrets F₁ . . . Fₙ, where K₁=B₁^{F1} mod P, . . . , Kₙ=BₙFⁿ mod P. The verifier assumes that those hardware devices are still trusted. The verifier and the trusted hardware device would then perform the following protocol to verify that membership of an owner of a trusted hardware device is not revoked, as shown in FIGS. 11 and 12.

FIG. 11 is a flowchart illustrating a method 800 performed by a verifier to verify that membership of an owner of a trusted member device within a trusted membership group is not revoked according to one embodiment. Representatively, at process block 810 it is determined whether verification of user revocation is requested. Once requested at process block 820, the verifier gives base and pseudonym pairs of a revocation list {(B₁, K₁) . . . (Bₙ, Kₙ)} to the member. Let F be the secret held by this member. At process block 830, the verifier receives a non-revoked message and a corresponding DP/DAA signature if the member device is able to verify that is has not been revoked according to the pseudonym pairs provided at process block 820. At process block 840, the verifier verifies the correctness of the DP/DAA signature. If such signature is verified as valid, the revocation check succeeds at process block 850. Otherwise, revocation fails at process block 842.

FIG. 12 is a flowchart illustrating a method 900 to allow a trusted member device to prove the denial of user revocation according to one embodiment. Representatively, at process block 910, it is determined whether a user revocation request is received. Once received at process block 920, the prover receives a revocation list from the verifier including base and pseudonyms (B₁, K₁) . . . (Bₙ, Kₙ). Let F be the secret held by this member. At process block 930, the device first verifies the authenticity of the pseudonyms (i.e., checks whether they are signed by a trusted revocation server or by the issuer). At process block 950, the device then verifies that it has not been revoked in (B₁, K₁) . . . (Bₙ, Kₙ) by verifying K₁≠B₁^{F} mod P, . . . , Kₙ≠Bₙ^{F} mod P. If the above verifications pass, at process block 950 the device produces a DP or DAA signature, stating that it was not the creator of these (B₁, K₁) . . . (Bₙ, Kₙ) pairs.

As shown in FIGS. 11 and 12, the revocation method is valid under the assumption that the hardware devices containing the secrets F₁ . . . Fₙ have not been corrupted. Conversely, if the device indeed contained one of the secrets F₁ . . . Fₙ and was thus the creator of one of the pseudonym pair (Bᵢ, Kᵢ), then the device would not sign any statement at block 960 of FIG. 12.

In one embodiment, if the issuer had revoked a set of users of hardware devices, a further optimization is possible. In the issuing, each user creates a pseudonym with a fixed base, B_{I}. Thus the list of pseudonym pairs to be revoked would be of the form, (B_{I}, K₁), . . . , (B_{I}, Kₙ). Then, in process block 960 of FIG. 12, the device would need to compute just a single K=B_{I}^{F} mod P, and verify that K was not one of the K₁, . . . , Kₙ. Thus doing a single exponentiation instead of n. Also, the device could have stored K=B_{I}^{F} mod P since it is the same B_{I} used every time, so that even this single exponentiation can be eliminated.

In the embodiment described, various different revocation methods may be used. All or some subset of these methods may be used in a single transaction. For example, when the verifier has the private key, F, that has been removed from a device, the verifier can get a signature from a device, and can check whether that signature was created by the compromised private key by taking the base and pseudonym pair (B,K) used by the device in the signature, and rejecting the signature if B^{F}=K. As a further example, there may be a list of issuer base name, pseudonym pairs, (B_{I}, K₁), . . . , (B_{I}, Kₙ) for which the verifier requires a proof from the device that it did not create one of these pairs to be valid even if the corresponding Fᵢ has been compromised. In this case, the device would do the proof that it had an F different from each of these Fᵢ using one of the above described embodiments. In one embodiment, there may be a list of random base name, pseudonym pairs, (B₁, K₁) for which the verifier wants the proof from a device that it did not create one of these pairs to be valid even if the corresponding Fᵢ has been compromised. In this case, the device would do the proof described in FIG. 10 that it had an F different from each of these Fᵢ.

In one embodiment, there may be a list of issuer base name, pseudonym pairs, (B_{I}, K₁), . . . , (B_{I}, Kₙ) for which the verifier wants a statement from a device that it did not create one of these pairs and there is no requirement that the proof be valid if the device that created one of the pseudonym pairs on list has been compromised. In this case, the device would compute K=B_{I}^{F} mod P, and check that this was not on this list K₁, . . . , Kₙ, and then sign a statement indicating whether or not this check passed. For example, there may be a list of random base name, pseudonym pairs, (B₁, K₁), . . . , (Bₙ, Kₙ) for which the verifier wants a statement from a device that it did not create one of these pairs and there is no requirement that the proof be valid if the device that created one of the pseudonym pairs on list has been compromised. In this case, the device would check that K₁ not equal B₁^{F} mod P, . . . , Kₙ not equal Bₙ^{F} mod P and then sign a statement indicating whether or not all of these checks passed.

In one embodiment, there may be a list of base name, pseudonym pairs for which the verifier wants a statement from the device that it did create one of these pairs, and the verifier is satisfied with a proof that is valid if the device that created one of these pairs has been compromised, but would like to do some additional checking just in case one of those devices has been compromised. In this case, the verifier can ask first for the signed statement that the device did not create one of these pairs, and then the verifier can randomly pick some subset of the list, and ask the device to form the proof that the device did not create any of the pairs on the subset. Then the verifier will have some nonzero probability of detecting a device on this list that had been compromised, and this is more efficient than having every device form the proof for every item on the list.

In applying this method to a driver's license, there may be different revocation authorities, and different authorizations for different types of verifiers. A bar or restaurant that serves alcoholic beverages may use a list that includes only licenses for which the key has been reported compromised, or the license is reported lost, or for which an error has been found with the registration process. This revocation list would be signed by a revocation authority, and may not need any authorization to use this revocation list, although this list would be signed by a revocation authority. An officer checking the license for validity at an airport may have a revocation list that includes in addition licenses that belong to people who are wanted for apprehension by law enforcement. This list could use the named base B_{I} used in the issuing process, since the identity of the people on this list would be known. The use of this list may need authorization in addition to a signature by a revocation authority. Thus when the airport officer submits the list to the license, the officer would need to authenticate to the license that he had the authority to that revocation list. A highway patrol officer may have a list that includes in addition the list of people with a revoked or suspended drivers license. This list could also use the named base B_{I} used in the issuing process, since the identity of the people on this list would be known. The use of this list would also need authorization in addition to a signature by a revocation authority. So the highway patrol officer would also need to authenticate to the license that he had the authority to use that list.

One method for providing the authorization of an officer to use a particular revocation list is as follows. The license contains one or more keys for checking the validity of a revocation list. The license contains one or more “root keys for authorization” for checking the authorization for someone making a request for the license to prove that it is not on a particular revocation list. Every law enforcement officer that needed to check for additional revocations would have a public/private key pair, with the public key in a certificate issued within the certificate hierarchy of the root key for authorization. The law enforcement officer certificate would indicate what revocation lists he was allowed to use. For example, the list that the bar would use may have an indication that the list did not need authorization. A list that is used at an airport may indicate that it could be used by any individual with the authority to check whether the individual was wanted by law enforcement. Correspondingly, any officer at the airport would have a certificate stating that they were authorized to submit a list which contained individuals wanted by law enforcement. When the license was given a list of individuals wanted by law enforcement, the license would check that the individual making the request had a certificate validated through the root key for authorization that authorized them to submit that list. Similarly, the highway patrol officer would have a certificate that granted him the authority to submit lists that contained licenses for which the driving privilege had been revoked or suspended. This concept can clearly be extended to include other types of revocation lists and authorities.

In one embodiment, the platform has an auditing capability on the revocation lists that it has been given. The platform would store the type and version of revocation list that it was given, and if available the time the list was provided. It would also store the authorization information of the individual providing the authorization to use the revocation list. The platform would provide this information to the owner of the platform upon request. Thus the platform owner would be able to do an audit of the revocation lists that it had been, and thus detect if it had been given an inappropriate list.

When a platform is on one of the revocation lists, the platform will know that fact. In one embodiment, the platform will keep that information and any authorization information that was provided when the revocation list was submitted. In one embodiment the time of the request is also submitted and stored. In one embodiment, there is a policy associated with the revocation list that indicates when the platform is allowed to inform the owner of the platform that he was given a revocation list. For some types of uses, and types of revocation lists, it may be appropriate for the user to be provided immediate information that the platform was on a revocation list. For other types, the policy may indicate that some period of time must pass before the user is notified that his platform was on a revocation list. The platform could have a maximum time which could be indicated by any policy. This provides the property that the owner of a platform will be assured that if his platform is ever on some type of revocation list, he will eventually become informed of that. The platform owner could check this information by sending a request for any revocation list information to the platform. If the platform is a smart card, as in the case of a driver's license, the platform would need to be placed in a smart card reader to process this request.

In an alternate method, when a verifier asks for a signature, he gives a revocation identifier. In one embodiment, when a member is presented with a revocation identifier, the prover platform will limit signature denial to requests, including the same revocation identifier. The revocation identifier could be indicated by the low order bits of the value of B, for instance, the low order 40 bits. The verifier would indicate these low order bits of B, and the prover would use these low order bits of B, and select the rest of the bits of B randomly. The prover would then only provide a denial for signatures in which the B₀ matched these low order bits. In this way, verifier platforms could be placed into groups where two verifiers are in the same group if they used the same revocation identifier. Within a group, a verifier could tell other verifiers to reject a member key, but they could not tell verifiers outside the group to reject the member key. In one embodiment, this method may also include a limit on the number of issued denial of signature requests.

The previous application also includes a non-interactive method for Direct Proof. In addition, there have been other methods discovered for performing Direct Proof. One of these was presented by Brickell, Boneh, Chen, and Shacham and was called set signatures. Another was presented by Brickell, Camenisch, and Chen and was called Direct Anonymous Attestation. Another was described within co-pending U.S. application Ser. No. 11/778,804, entitled “An Apparatus and Method for Direct Anonymous Attestation From Bilinear Maps,” filed on Jul. 17, 2007, and using computations over elliptic curves instead of modular exponentiation. All of these methods share the property that there is a random base option such that in the creation of the signature or the interactive proof, the member creates a pseudonym, k=B^{f} in some finite group, such as the integers modulo Q for some integer Q. Thus, the method described in this invention for proving the denial of a signature can be applied to any of these signature or interactive methods as well.

Having disclosed exemplary embodiments and the best mode, modifications and variations may be made to the disclosed embodiments while remaining within the scope of the embodiments of the invention as defined by the following claims.

What is claimed is:

1. A method comprising:
receiving a denial of user revocation request from a verifier, including an issuer revocation listed having a plurality of revoked tokens received by an issuer during join procedures to establish membership within a trusted membership group of the issuer; and
convincing the verifier that a token generated by an anonymous hardware device during a join procedure with the issuer does not match any of the revoked tokens received with the denial of user revocation.

2. The method of claim 1, wherein prior to receiving, the method further comprises:
(a) verifying, by the anonymous hardware device, that membership of the anonymous hardware device within a trusted membership group is not revoked according to an authenticated revocation list received with an authentication request from the verifier;
(b) transmitting, by the anonymous hardware device, a digital signature computed on a message received with the authentication request to the verifier if membership of the anonymous hardware device within the trusted membership group is verified in (a), the verifier to authenticate the digital signature according to a public key of the trusted membership group to enable a trusted member device to remain anonymous to the verifier; and
(c) receiving the denial of user revocation request if membership of the anonymous hardware device within the trusted membership group created by the issuer is established by the verifier according to the digital signature computed on a message received with the authentication request from the verifier.

3. The method of claim 1, wherein receiving further comprises:
receiving a challenge request from the verifier including a revocation list having a base value B_{I} of the issuer and a plurality of revoked pseudonyms (K₁, . . . , Kₙ) received by the issuer during join procedures for the trusted membership group, where n is an integer greater than 1;
authenticating a digital signature of the received revocation list according to a public key of a trusted revocation server;
verifying that the verifier is authorized to issue the revocation list; and
verifying that a pseudonym K does not equal any of the revoked pseudonyms, where K is of the form K=B_{I}^{F} mod P, F is the private member key and P is a public modulus for the trusted membership group.

4. The method of claim 1, wherein issuing further comprises:
initiating a proof of membership protocol in response to the received authentication request to prove membership within the trusted membership group to the verifier, the request including the revocation list having a plurality of revoked tokens;
authenticating the revocation list according to a public key of a trusted revocation server; and
aborting the proof of membership protocol if a private member key stored within the anonymous hardware device was previously used to compute a revoked token within the revocation list.

5. The method of claim 1, wherein convincing further comprises:
computing a digital signature as an attestation that the token generated by the trusted member device during the join procedure with the issuer to establish membership within the trusted membership group does not match any of the revoked tokens; and
transmitting the digital signature to the verifier to provide user authentication.

6. The method of claim 1, wherein convincing further comprises:
selecting a random value R;
computing values of the form U=B_{I}^{R} mod P, W=U^{F} mod P and Vᵢ=Kᵢ^{R} mod P, where n is an integer greater than 1, i is a value from 1 to n and F is a private member key of the anonymous hardware device;
sending the values U, W and (V₁, . . . , Vₙ) to the verifier; and
proving to the verifier that there exists an R such that U=B^{R} mod P and Vᵢ=Kᵢ^{R} mod P without disclosure of the private member key or any unique device identification information of the hardware device.

7. The method of claim 6, further comprising:
proving to the verifier that there exists a private member key F, such that W=U^{F} mod P and K=B^{F} mod P, without disclosure of the private member key or any unique device identification information of the hardware device.

8. A method comprising:
authenticating a digital signature computed on a message sent with an authentication request to an anonymous hardware device according to a public key of a trusted membership group to enable a trusted member device to remain anonymous to a verifier; and
issuing a denial of user revocation request to the trusted member device including a plurality of revoked tokens received by an issuer during join procedures to establish membership with the trusted membership group if membership of the anonymous hardware device within the trusted membership group created by the issuer is established by the verifier according to the digital signature.

9. The method of claim 8, wherein authenticating further comprises:
verifying that the anonymous hardware device possesses cryptographic information issued from the issuer of the trusted membership group without determining the cryptographic information or any unique device identification information of the hardware device; and
verifying that a private member key of the hardware device was not used to generate any one of a group of suspect signatures, held by a verifier, where suspect keys used to generate the suspect signature are unknown to the verifier without determining the private member key or any unique device identification information of the hardware device.

10. The method of claim 8, wherein authenticating further comprises:
issuing an authentication request to an anonymous hardware device to prove membership within a trusted membership group, the authentication request including a revocation list having a plurality of revoked tokens of a plurality of suspect signatures received from a trusted revocation server; and
receiving a digital signature computed on a message sent with the authentication request to the device if the anonymous hardware device verifies that membership of the anonymous hardware device within a trusted membership group is non-revoked.

11. The method of claim 8, wherein prior to issuing the hardware challenge, the method comprises:
detecting unauthorized activity of an anonymous member device;
determining pseudonym K generated by the device during a join procedure with the issuer of the trusted membership group; and
sending an issuer base name B_{I} and the pseudonym K to a trusted revocation server to revoke membership of the device within the trusted membership group.

12. The method of claim 8, wherein authenticating further comprises:
(a) verifying a first signature of knowledge that the anonymous hardware device possesses a private member key generated during a join procedure with the issuer to establish membership within the trusted membership group;
(b) verifying a second signature of knowledge that the private member key of the anonymous hardware device has not been revoked if the private member key was not used to compute a matching pseudonym pair of one of a plurality of suspect signatures within the revocation list received from the verifier; and
establishing authentication of the digital signature if the first and second signature of knowledge a re verified, as determined in (a) and (b).

13. The method of claim 8, further comprising:
receiving a digital signature from the trusted member device as an attestation that the token generated by the device during the join procedure with the issuer to establish membership within the trusted membership group does not match any of the revoked tokens.

14. The method of claim 1, wherein issuing the denial of revocation further comprises:
verifying that a membership private key of the anonymous hardware device is uncompromised if the private member key of the hardware device was not used to generate any one of the group of suspect signatures held by the verifier, where suspect keys used to generate the suspect signatures are unknown to the verifier;
transmitting the denial of revocation requests to the trusted member device if the private member key of the device is established as uncompromised;
receiving a digital signature from the anonymous hardware device stating that it was not the creator of any of the revoked tokens in the revocation list if the hardware device verifies that the private member key does not generate any of the revoked tokens contained in the revocation list according to a pre-determined computation; and
receiving a digital signature from the hardware device that a holder of the hardware device has been revoked from the trusted membership group if the pre-determined computation using the private member key of the hardware device matches a revoked token from the revocation list.

15. An apparatus comprising:
a flash memory to store cryptographic information from an issuer;
a trusted platform module (TPM) to convince a verifier that a TPM possesses cryptographic information from an issuer of a trusted membership group without disclosure of the cryptographic information or any unique device identification information of the apparatus;
digital signature logic to issue a signature on a message received with an authentication request from a verifier; and
denial of user revocation logic to convincing the verifier that a token generated during a join procedure with the issuer to establish membership within the trusted membership does not match any of the revoked tokens contained within a revocation list received with a denial of user revocation request from the verifier.

16. The apparatus of claim 15, wherein the trusted platform module comprises:
denial of signature logic to receive a group denial of signature request, including plurality of pseudonym pairs (B₁, K₁) . . . (Bₙ, Kₙ) including a base value Bᵢ and a pseudonym value Kᵢ generated during login procedures with an issuer to establish membership within the trusted membership group;
authentication logic to verify that a private member key F stored within the hardware device used to construct a pseudonym, K, does not match any one of a plurality of unknown, member keys F₀ . . . Fₙ generated during the join procedures or a signature generation procedures if Kᵢ≠Bᵢ^{F} mod P, where n is an integer greater than 1 and i is and integer from 1 to n.

17. The apparatus of claim 15, wherein the trusted platform module comprises:
key logic to receive a unique secret pair (c,F) from a certifying manufacturer of the apparatus where F is a signature key of the hardware device of the form c^{e} mod P, where the pair (e, P) is a public key of the certifying manufacturer.

18. The apparatus of claim 15, wherein the apparatus comprises one of a smart card, a bank card, a credit card and an identification card having an integrated circuit including the TPM.

19. The apparatus of claim 15, further comprising:
membership verification logic to determine whether membership of the anonymous hardware device within a trusted membership group is not revoked according to an authenticated revocation list received with an authentication request from a verifier.

20. A system comprising:
a verifier platform coupled to a network; and
an anonymous prover platform coupled to the network, comprising:
a bus,
a processor coupled to the bus,
a chipset coupled to the bus, including a trusted platform module (TPM), in response to a denial of user revocation request received over the network, the TPM to verify that membership of the user of the anonymous hardware device within a trusted membership group is not revoked according to an authenticated issuer revocation listed having a plurality of revoked tokens received by an issuer during join procedures to establish membership within a trusted membership group of the issuer and convincing the verifier that a token generated by an anonymous hardware device during a join procedure with the issuer does not match any of the revoked tokens received with the denial of user revocation.

21. The system of claim 20, wherein the verifier platform comprises:
digital signature verification logic to issue a digital signature computed on a message received with an authentication request to the verifier if membership of the anonymous hardware device within a trusted membership group is verified according to an authenticated verifier.

22. The system of claim 20, wherein the trusted platform module comprises:
denial of revocation logic to receive the denial of signature request, including plurality of pseudonym pairs (B₁, K₁) . . . (Bₙ, Kₙ) including a base value Bᵢ and a pseudonym value Kᵢ of plurality of suspect signatures from the verifier and to convince the verifier that a private member key F stored within the hardware device does not match any one of a plurality of unknown, suspect keys F₀ . . . Fₙ generated during a join procedure with the issuer of the trusted membership group if Kᵢ≠Bᵢ^{F} mod P, where F is the private member key and P is a public modulus for the trusted membership group n is an integer greater than 1 and i is and integer from 1 to n.

23. The system of claim 20, wherein the prover platform in Direct Proof comprises:
key logic to generate a secret member key, F, according to a predetermined seed value B
join logic to compute cryptographic parameters for receiving a group membership certificate c of the prover platform, the private signature key (F, c) of the prover platform including the secret member key F and cryptographic parameter c of the group membership certificate of the prover platform.

24. The system of claim 20 wherein the prover platform comprises an identification card having an integrated circuit including the TPM.

25. An article of manufacture including a machine readable medium having stored thereon instructions which may be used to program a system to perform a method, comprising:
issuing, by an anonymous hardware device, a digital signature to a verifier, the digital signature computed on a message received with an authentication request from the verifier;
receiving a denial of revocation requests, including a plurality of revoked tokens received by an issuer during join procedures for a trusted membership group, the denial of revocation request received if membership of the anonymous hardware device within the trusted membership group created by the issuer is established by the verifier according to the digital signature; and
convincing the verifier that a token generated by the anonymous hardware device during a join procedure with the issuer does not match any of the revoked tokens received by the issuer during the join procedures.

26. The article of manufacture of claim 25, wherein verifying that the hardware device possesses cryptographic information comprises:
computing a first signature of knowledge that the anonymous hardware device possesses a private member key issued by the issuer of the trusted membership group during a join procedure;
computing a second signature of knowledge that the private member key of the anonymous hardware device has not been revoked if the private member key was not used to compute a matching pseudonym; and
combining the first signature of knowledge and the second signature of knowledge to form the digital signature on the message received with the authentication request.

27. The article of manufacture of claim 25, wherein receiving further comprises:
authenticating a digital signature of the received revocation list according to a public key of a trusted revocation server; and
verifying that a pseudonym K does not equal any of the revoked pseudonyms, where K is of the form K=B_{I}^{F} mod P, F is the private member key and P is a public modulus for the trusted membership group.

28. The article of manufacture of claim 25, wherein receiving further comprises:
computing a digital signature as an attestation that the token generated by the trusted member device during the join procedure with the issuer to establish membership within the trusted membership group does not match any of the revoked tokens; and
transmitting the digital signature to the verifier to provide user authentication.
